(19) United States
(12) Patent Application Publication
(10) Pub. No.: US 2013/0040135 A1
(43) Pub. Date: Feb. 14, 2013

(54) INORGANIC OXIDE PARTICLE CONTAINING SILICONE RESIN SHEET

(71) Applicant: Keisuke HIRANO, Osaka (JP)

(72) Inventor: Keisuke HIRANO, Osaka (JP)

(73) Assignee: NITTO DENKO CORPORATION, Osaka (JP)

(21) Appl. No.: 13/569,372

(22) Filed: Aug. 8, 2012

(30) Foreign Application Priority Data
Aug. 8, 2011 (JP) 2011-173010
Aug. 8, 2011 (JP) 2011-173011

(51) Int. Cl. C08G 77/14; C09J 7/02

(52) U.S. Cl. 428/353; 528/37

(57) ABSTRACT

There are provided a silicone resin sheet having high heat resistance and strength and being excellent in flexibility, and a pressure-sensitive adhesive sheet having excellent anchoring, force and excellent moisture resistance. The inorganic oxide particle-containing silicone resin sheet according to the present invention includes a silicone resin composition containing a crosslinked structure in which an inorganic oxide particle dispersed in a polysiloxane resin and the polysiloxane resin are crosslinked through a chemical bond, and has a tensile elongation of 5 to 15%. The primer composition for a carboxyl group-containing adhesive according to the present invention is a primer composition used for a pressure-sensitive adhesive sheet having a pressure-sensitive adhesive layer containing a carboxyl group-containing polymer as a base polymer, and contains a crosslinked structure in which a polysiloxane compound is crosslinked through a chemical bond to the surface of a core including an inorganic oxide particle.

### TECHNICAL FIELD

The present invention relates to an inorganic oxide particle-containing silicone resin sheet, and more particularly to an inorganic oxide particle-containing silicone resin sheet having a flexibility comparable with organic resin sheets.

The present invention also relates to a primer composition and a pressure-sensitive adhesive sheet, and more particularly to a primer composition used for a pressure-sensitive adhesive sheet having a pressure-sensitive adhesive layer comprising a pressure-sensitive adhesive containing a carboxyl group, and a pressure-sensitive adhesive sheet having an undercoat layer comprising the primer composition provided therein.

### BACKGROUND ART

Conventionally, glasses are transparent in the visible light region, simultaneously have various excellent characteristics such as heat resistance, weather resistance, light resistance, strength, solvent resistance and water resistance, and are used in various types of applications such as windows of houses, cars and the like, and surfaces of television sets and displays. However, the glasses generally have a problem of lacking flexibility. In recent years, size reduction, thickness reduction, weight reduction and the like of displays and the like have been demanded, and transparent sheets having a strength and stability comparable with glasses and simultaneously having flexibility have been demanded.

Demands for flexible, stable and transparent sheets have been raised, for example, in flexible displays and flexible solar cells conforming to curved surfaces, or OLED illuminations whose research has extensively progressed recently. As described in Patent Literature 1, although an attempt is made therefor in which glass is ground to form the glass into a thin film, and bent, the film thickness, the bendable angle and the like have large limitations.

Then, as shown in Patent Literature 2, an attempt is made in which a thin film glass is fabricated as a flexible glass by a sol-gel method or the like. Although a flexibility of the thin film glass is tried to be developed by thinning the film thickness because the thin film glass is generally hard and brittle though a compound based on a Q unit being a tetrafunctional alkoxysilane is generally used as a main component, the film thickness, the bendable angle and the strength have limitations.

By contrast, although polymer sheets being organic materials, as flexible materials, are excellent in flexibility, easy in control of the film thickness, and excellent in versatility, the polymer sheets are largely inferior in heat resistance, weather resistance and light resistance to glasses and the like, and have limitations in usable conditions and the like.

Among the flexible materials, silicone resins have silicon-oxygen bonds whose bond energy is higher than that of carbon-carbon bonds of general organic substances, and therefore, the silicone resins are superior in heat resistance, light resistance and the like to organic polymers. As silicone resins, MQ resins generally derived from tetrafunctional and monofunctional alkoxysilanes, and DT resins derived from trifunctional and bifunctional alkoxysilanes are well known. Although MQ resins are generally hard and are used for hard coat agents and the like, since having a low molecular weight and being brittle, the MQ resins cannot provide flexible sheets.

On the other hand, as described in Patent Literature 3, although polysilsesquioxane being a condensate of trifunctional components is said to be able to form a relatively flexible film, since many cyclic compounds having a cage structure, a ladder structure and the like are produced during the condensation reaction, the molecular weight is about 2,000 and is hardly raised, and it is difficult to fabricate a flexible sheet. On the other hand, although DT resins are materials composed of a trifunctional T unit being a hard component and a bifunctional D unit being a flexible component, the amount of the D unit needs to be made large in order to raise the molecular weight. However, since the D unit is a linear molecule and a rubber component, the DT resins do not return to their original shape as they are elongated when being stretched, though being flexible, and have a problem with the strength. As described in the above, it is very difficult for silicone resins as single substances to provide transparent flexible sheets having a heat resistance and strength comparable with inorganic glasses and having a flexibility comparable with organic resins.

On the other hand, adhesive sheets are conventionally used widely in various types of industrial fields, and have a base material and a pressure-sensitive adhesive layer laminated thereon. In order to improve the anchoring force, it is known that an undercoat layer is interposed between the base material and the pressure-sensitive adhesive layer.

For example, Patent Literature 4 proposes a primer composition obtained by blending an ethylamino binder (ethyleneimine-based binder) with an aqueous colloidal silica, and a pressure-sensitive adhesive sheet in which an undercoat layer formed of such a primer composition is interposed between a base material and a pressure-sensitive adhesive layer.

### CITATION LIST

### Patent Literature

Patent Literature 1: Japanese Patent Laid-Open No. 2010-132532
Patent Literature 2: Japanese Patent Laid-Open No. 2004-046031
Patent Literature 3: Japanese Patent Laid-Open No. 2008-248236
Patent Literature 4: Japanese Patent Laid-Open No. 2000-327955

### SUMMARY OF INVENTION

### Technical Problem

A better anchoring force has recently been demanded for adhesive sheets, and the above-mentioned adhesive sheet has an insufficient anchoring force in some cases. Particularly since adhesive sheets are liable to decrease in the anchoring force in a high-temperature high-humidity atmosphere, an excellent moisture resistance is required. In production of adhesive sheets, the improvement of coatability of a primer composition is desired.

Therefore, it is an object of the present invention to provide a silicone resin sheet having a high heat resistance and strength, and being excellent in flexibility.

It is an object of the present invention to further provide a silicone resin sheet excellent in transparency as well.

It is another object of the present invention to provide a pressure-sensitive adhesive sheet having an excellent anchoring force and an excellent moisture resistance.

It is still another object of the present invention to provide a primer composition good in coatability and useful for forming an undercoat layer of a pressure-sensitive adhesive sheet having an excellent anchoring force and an excellent moisture resistance.

### Solution to Problem

As a result of exhaustive studies to achieve the above-mentioned objects, the present inventors have found that by causing an inorganic oxide particle having a strength to firmly bond with a silsesquioxane-based material comprising a T unit, which has balanced hardness and brittleness, in place of a Q unit, which is hard but brittle, a heat resistance and strength comparable with glasses are held; and by causing the resultant to further link with a DT resin comprising a T unit and a flexible D unit, a flexibility comparable with organic resins can be imparted while the heat resistance and strength are maintained. Further as a result of exhaustive studies to achieve the above-mentioned objects, the present inventors have found that if an undercoat layer comprising a composition containing a crosslinked structure in which an inorganic microparticle and a polysiloxane compound are crosslinked through a chemical bond is provided between a base material and a pressure-sensitive adhesive layer, the anchoring force and the moisture resistance can be improved remarkably. The present invention has been completed based on these findings and further by much research.

That is, the present invention provides an inorganic oxide particle-containing silicone resin sheet comprising a silicone resin composition containing a crosslinked structure in which an inorganic oxide particle dispersed in a polysiloxane resin and the polysiloxane resin are crosslinked through a chemical bond, and the resin sheet having a tensile elongation of 5 to 15%.

The tensile elastic modulus of the inorganic oxide particle-containing silicone resin sheet is preferably in the range of 50 to 250 MPa.

The 5%-weight loss temperature of the inorganic oxide particle-containing silicone resin sheet is preferably 380° C. or higher.

The total light transmittance (thickness: 100 μm) of the inorganic oxide particle-containing silicone resin sheet is preferably 88% or higher.

The tensile strength of the inorganic oxide particle-containing silicone resin sheet is preferably 8 N/mm² or higher.

As the polysiloxane resin, a condensation-reactive group-containing polysilsesquioxane having a T unit as a basic structural unit, and a condensation-reactive group-containing polysiloxane having a D unit and a T unit as basic structural units are preferably used.

The present invention also provides a primer composition for a carboxyl group-containing adhesive which composition is used for a pressure-sensitive adhesive sheet having a pressure-sensitive adhesive layer containing a carboxyl group-containing polymer as a base polymer, and which composition contains a crosslinked structure in which a polysiloxane compound is crosslinked through a chemical bond to the surface of a core comprising an inorganic oxide particle.

The proportion of an inorganic oxide particle in the crosslinked structure is preferably 1 to 30 parts by weight based on 100 parts by weight of the polysiloxane compound.

The polysiloxane compound is preferably an alkoxysilyl group-containing polysiloxane having a D unit and a T unit as basic structural units, and/or an alkoxysilyl group-containing polysilsesquioxane having a T unit as a basic structural unit.

The present invention further provides a pressure-sensitive adhesive sheet which has a base material, and a pressure-sensitive adhesive layer containing a carboxyl group-containing polymer as a base polymer, and which has an undercoat layer formed of the primer composition for a carboxyl group-containing adhesive between the base material and the pressure-sensitive adhesive layer, wherein the carboxyl group-containing polymer is an acrylic polymer containing 1 to 10% by weight of a structural unit originated from a carboxyl group-containing monomer based on all monomer structural units.

### Advantageous Effects of Invention

The inorganic oxide particle-containing silicone resin sheet according to the present invention, since having a crosslinked structure formed by crosslinking of an inorganic oxide particle having a strength through a chemical bond with a polysiloxane resin, and having a tensile elongation of 5 to 15%, has a high heat resistance and strength comparable with inorganic glasses and also an excellent flexibility comparable with organic resins.

The primer composition according to the present invention, since comprising a crosslinked structure in which an inorganic oxide particle and a polysiloxane compound are crosslinked through a chemical bond, is excellent in coatability. The pressure-sensitive adhesive sheet according to the present invention, which is a pressure-sensitive adhesive sheet having a base material, and a pressure-sensitive adhesive layer containing a carboxyl group-containing polymer as a base polymer, and which has an undercoat layer formed of the primer composition according to the present invention between the base material and the pressure-sensitive adhesive layer, has an excellent anchoring force. The pressure-sensitive adhesive sheet according to the present invention, since having an excellent moisture resistance, can further secure excellent reliability even in a high-temperature high-humidity atmosphere.

### BRIEF DESCRIPTION OF DRAWINGS

FIG. 1 shows a schematic enlarged cross-sectional diagram of one embodiment of the pressure-sensitive adhesive sheet according to the present invention.

### DESCRIPTION OF EMBODIMENTS

### Inorganic Oxide Particle-Containing Silicone Resin Sheet

The inorganic oxide particle-containing silicone resin sheet according to the present invention comprises a silicone resin composition containing a crosslinked structure in which an inorganic oxide particle dispersed in a polysiloxane resin and the polysiloxane resin are crosslinked through a chemical bond, and has a tensile elongation of 5 to 15%.

### Inorganic Oxide Particle

The inorganic oxide particle suffices if being an inorganic oxide particle having a reactive functional group on the particle surface, and examples thereof include silica (SiO₂ or SiO), alumina (Al₂O₃), antimony-doped tin oxide (ATO), titanium oxide (titania, TiO₂) and zirconia (ZrO₂). Above all, especially silica is preferable. The inorganic oxide particle may be used singly or concurrently in two or more.

Examples of the reactive functional group include a hydroxyl group, an isocyanate group, a carboxyl group, an epoxy group, an amino group, a mercapto group, a vinylic unsaturated group, a halogen atom and an isocyanurate group. Above all, a hydroxyl group is preferable. The hydroxyl group on the silica particle surface is present as a silanol group.

The average particle diameter (primary particle diameter) of the inorganic oxide particle is generally 1 to 1,000 nm, preferably 1 to 500 nm, more preferably 1 to 200 nm, and especially preferably 1 to 100 nm. The average particle diameter can be measured by a dynamic light scattering method or the like.

The particle size distribution of the inorganic oxide particle is desirably as narrow as possible, and is desirably a monodispersion state in which the particles are dispersed with the primary particle diameter. The surface potential of the inorganic oxide particle is preferably in an acidic region (for example, pH 2 to 5, preferably pH 2 to 4). The surface potential in the range suffices if being a surface potential at the reaction with a polysiloxane resin.

The inorganic oxide particle to be used is preferably a colloidal one. Examples of the colloidal inorganic oxide particle include colloidal silica, colloidal alumina (alumina sol), colloidal tin oxide (tin oxide water-dispersion) and colloidal titanium oxide (titania sol).

Examples of the colloidal silica include colloids of microparticles (whose average particle diameters are, for example, 5 to 1,000 nm, preferably 10 to 100 nm) of silicon dioxide (anhydrous silicic acid), for example, as described in Japanese Patent Laid-Open No. S53-112732, Japanese Patent Publication No. S57-9051 and Japanese Patent Publication No. S57-51653.

The colloidal silica, as required, may contain, for example, alumina and sodium aluminate, and as required, also may contain a stabilizer such as an inorganic base (for example, sodium hydroxide, potassium hydroxide, lithium hydroxide and ammonia) or an organic base (for example, tetramethylammonium).

Such a colloidal silica is not especially limited in its production method, and can be produced, for example, by known sol-gel methods specifically described, for example, in Werner Stober et al; J. Colloid and Interface Sci., 26, 62-69 (1968), Rickey D. Badley et al; Langmuir 6, 792-801 (1990) and Journal of the Japan Society of Colour Material, 61 [9] 488-493 (1988), or other references.

The colloidal silica is preferably in a bare state in which no surface treatment has been made. There are present silanol groups as surface functional groups on the colloidal silica.

As such a colloidal silica, commercially available products are usable, and specific examples thereof include trade names of “Snowtex-XL”, “Snowtex-YL”, “Snowtex-ZL”, “PST-2”, “Snowtex-20”, “Snowtex-30”, “Snowtex-C”, “Snowtex-O”, “Snowtex-OS”, “Snowtex-OL” and “Snowtex-50” (hitherto, made by Nissan Chemical Industries, Ltd.), and trade names of “Adelite AT-30”, “Adelite AT-40” and “Adelite AT-50” (hitherto, made by Nippon Aerosil Co., Ltd.). Above all, trade names of “Snowtex-O”, “Snowtex-OS”, “Snowtex-OL” and the like are especially preferable.

Colloidal inorganic particles also usable other than the colloidal silicas are commercially available products, and specific examples include alumina sols (hydrosols) such as trade names of “AluminaSol 100”, “AluminaSol 200” and “AluminaSol 520” (hitherto, Nissan Chemical Industries, Ltd.), titania sols (hydrosols) such as a trade name of “TTO-W-5” (made by Ishihara Sangyo Kaisha, Ltd.) and a trade name of “TS-020” (made by Tayca), and tin oxide water-dispersions such as trade names of “SN-100D” and “SN-100S” (hitherto, Ishihara Sangyo Kaisha, Ltd.).

### Polysiloxane Resin

In the present invention, the polysiloxane resin (a polysiloxane resin participating in a reaction with an inorganic oxide particle) is not especially limited as long as being a polysiloxane compound having a reactivity with a functional group on the surface of the inorganic oxide particle. The polysiloxane compound is particularly preferably a condensation-reactive silicone resin. Examples of the condensation-reactive silicone resin include a condensation-reactive group-containing polysiloxane having a D unit and a T unit as basic structural units (hereinafter, referred to as “D/T-units condensation-reactive group-containing polysiloxane” in some cases) and a condensation-reactive group-containing polysilsesquioxane having a T unit as a basic structural unit (hereinafter, referred to as “condensation-reactive group-containing polysilsesquioxane” in some cases). These may be used singly or concurrently in two or more.

Among the condensation-reactive silicone resins, particularly a combination of a D/T-units condensation-reactive group-containing polysiloxane and a condensation-reactive group-containing polysilsesquioxane is preferable. By combining a D/T-units condensation-reactive group-containing polysiloxane and a condensation-reactive group-containing polysilsesquioxane, in a formed sheet, both the heat resistance and strength, and the flexibility can simultaneously be satisfied in high levels.

The condensation-reactive group includes silanol groups, alkoxysilyl groups (for example, C₁₋₆ alkoxysilyl groups), cycloalkyloxysilyl groups (for example, C₃₋₆ cycloalkyloxysilyl groups) and aryloxysilyl groups (for example, C₆₋₁₀ aryloxysilyl groups). Above all, alkoxysilyl groups, cycloalkyloxysilyl groups and aryloxysilyl groups are preferable, and alkoxysilyl groups are especially preferable.

In the present invention, the D/T-units condensation-reactive group-containing polysiloxane specifically contains a D unit represented by the following formula (1) and a T unit represented by the following formula (2) as basic structural units.

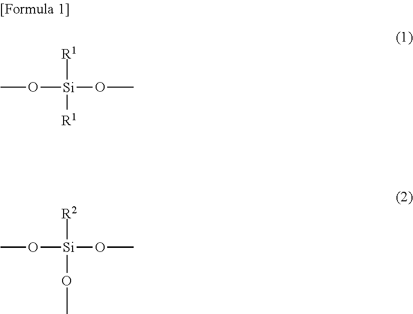

In the above formula (1), R¹ are identical or different, and denote a monovalent hydrocarbon group selected from saturated hydrocarbon groups and aromatic hydrocarbon groups. In the formula (2), R² denotes a monovalent hydrocarbon group selected from saturated hydrocarbon groups and aromatic hydrocarbon groups.

Examples of the saturated hydrocarbon group in the R¹ and R² include straight-chain or branched-chain alkyl groups having 1 to 6 carbon atoms such as a methyl, ethyl, propyl, isopropyl, butyl, isobutyl, pentyl and hexyl groups; and cycloalkyl groups having 3 to 6 carbon atoms such as a cyclopentyl and cyclohexyl groups. Examples of the aromatic hydrocarbon group in the R¹ and R² include aryl groups having 6 to 10 carbon atoms such as a phenyl and naphthyl groups.

R¹ and R² are preferably an alkyl group having 1 to 6 carbon atoms, or an aryl group having 6 to 10 carbon atoms, and more preferably a methyl group.

The D units represented by the formula (1) may be each identical or different in a D/T-units condensation-reactive group-containing polysiloxane, but are preferably identical. The T units represented by the formula (2) may be each identical or different in a D/T-units condensation-reactive group-containing polysiloxane, but are preferably identical.

A D/T-units condensation-reactive group-containing polysiloxane is a partial condensate of corresponding silicone monomers [for example, a partial condensate of bifunctional silicone monomers such as a dialkyl (or aryl)dialkoxysilane, and trifunctional silicone monomers such as an alkyl (or aryl)trialkoxysilane], and contains the D unit, the T unit, and a group represented by the following formula (3):

—OR³ (3)

in its structural units. The group represented by the formula (3) is bonded to a silicon atom, and is present at the molecular terminal.

The R³ denotes a monovalent hydrocarbon group selected from saturated hydrocarbon groups and aromatic hydrocarbon groups. The saturated hydrocarbon groups and the aromatic hydrocarbon groups include the similar ones as the saturated hydrocarbon groups and the aromatic hydrocarbon groups in R¹ in the above formula (1). R³ is preferably a saturated hydrocarbon group, more preferably an alkyl group having 1 to 6 carbon atoms, and especially preferably a methyl group or an ethyl group.

Examples of such a D/T-units condensation-reactive group-containing polysiloxane include alkoxysilyl group- (for example, C₁₋₆ alkoxysilyl group-)containing polymethylsiloxanes, alkoxysilyl group- (for example, C₁₋₆ alkoxysilyl group-)containing polymethylphenylsiloxanes and alkoxysilyl group- (for example, O₁₋₆ alkoxysilyl group-)containing polyphenylsiloxanes. These D/T-units alkoxysilyl group-containing polysiloxanes may be used singly or concurrently in two or more.

Among the D/T-units condensation-reactive group-containing polysiloxanes, preferable is a C₁₋₆ alkoxysilyl group-containing polysiloxane; more preferable is a methoxysilyl group-containing polysiloxane or an ethoxysilyl group-containing polysiloxane; and especially preferable is a methoxysilyl group-containing polymethylsiloxane of an ethoxysilyl group-containing polymethylsiloxane.

The content of a condensation-reactive group (for example, an alkoxysilyl group) of such a D/T-units condensation-reactive group-containing polysiloxane is, for example, 8 to 30% by weight, preferably 10 to 25% by weight, and more preferably 12 to 25% by weight. The content of the condensation-reactive group (for example, an alkoxysilyl group) can be determined from a proportion of the weight loss by TGA (differential weight loss measurement apparatus) when the temperature is raised from room temperature to 300° C.

The number-average molecular weight (by GPC measurement in terms of standard polystyrene) of a D/T-units condensation-reactive group-containing polysiloxane is, for example, in the range of 800 to 6,000, preferably 1,000 to 5,500, and more preferably 1,200 to 5,300.

As the D/T-units condensation-reactive group-containing polysiloxane, commercially available products (D/T-units alkoxysilyl group-containing polysiloxanes) such as trade names of “X-40-9246” and “X-40-9250” (hitherto, made by Shin-Etsu Chemical Co., Ltd.) may be used.

In the present invention, the condensation-reactive group-containing polysilsesquioxane specifically contains a T unit represented by the above formula (2) as a basic structural unit. The T units represented by the formula (2) may be each identical or different in a condensation-reactive group-containing polysilsesquioxane, but are preferably identical.

A condensation-reactive group-containing polysilsesquioxane is a partial condensate of corresponding silicone monomers [for example, a partial condensate of trifunctional silicone monomers such as an alkyl (or aryl) trialkoxysilane], and contains the T unit, and a group represented by the following formula (4):

—OR⁴ (4)

in its structural units. The group represented by the formula (4) is bonded to a silicon atom, and is present at the molecular terminal.

The R⁴ denotes a monovalent hydrocarbon group selected from saturated hydrocarbon groups and aromatic hydrocarbon groups. The saturated hydrocarbon groups and the aromatic hydrocarbon groups include the similar ones as the saturated hydrocarbon groups and the aromatic hydrocarbon groups in R¹ in the above formula (1). R⁴ is preferably a saturated hydrocarbon group, more preferably an alkyl group having 1 to 6 carbon atoms, and especially preferably a methyl group or an ethyl group.

The condensation-reactive group-containing polysilsesquioxane may be of any type of a random, ladder and cage types, but from the viewpoint of the flexibility, the random type is most preferable. These condensation-reactive group-containing polysilsesquioxanes may be used singly or concurrently in two or more.

Among the condensation-reactive group-containing polysilsesquioxanes, preferable is a C₁₋₆ alkoxysilyl group-containing polysilsesquioxane; more preferable is a methoxysilyl group-containing polysilsesquioxane or an ethoxysilyl group-containing polysilsesquioxane; and especially preferable is a methoxysilyl group-containing polymethylsilsesquioxane or an ethoxysilyl group-containing polymethylsilsesquioxane.

The content of a condensation-reactive group (for example, an alkoxysilyl group) of such a condensation-reactive group-containing polysilsesquioxane is, for example, 10 to 50% by weight, preferably 15 to 48% by weight, and more preferably 20 to 46% by weight. The content of the condensation-reactive group (for example, an alkoxysilyl group) can be determined from a proportion of the weight loss by TGA (differential weight loss measurement apparatus) when the temperature is raised from room temperature to 300° C.

The number-average molecular weight (by GPC measurement in terms of standard polystyrene) of a condensation-reactive group-containing polysilsesquioxane is, for example, in the range of 200 to 6,000, preferably 300 to 3,500, and more preferably 400 to 3,000.

As the condensation-reactive group-containing polysilsesquioxane, commercially available products (alkoxysilyl group-containing polysilsesquioxanes) such as the trade names of “KR-500” and “X-40-9225” (hitherto, made by Shin-Etsu Chemical Co., Ltd.) may be used.

In the present invention, the proportion of the total amount of a D/T-units condensation-reactive group-containing polysiloxane and a condensation-reactive group-containing polysilsesquioxane to the whole of the polysiloxane compound is preferably 50% by weight or larger, more preferably 70% by weight or larger, and especially preferably 90% by weight or larger.

In the present invention, as described above, a condensation-reactive group-containing polysilsesquioxane and a D/T-units condensation-reactive group-containing polysiloxane are preferably concurrently used. In this case, the proportion of the both is preferably particularly in the range of the former/the latter (weight ratio)=1/0.9 to 1/2.8. If the ratio of the condensation-reactive group-containing polysilsesquioxane is too high, the flexibility of a sheet is liable to decrease. By contrast, if the ratio of the D/T-units condensation-reactive group-containing polysiloxane is too high, the elastic modulus of a sheet decreases, and the tensile elongation becomes too large, and then, the practical utility is liable to be lacked.

### Content of an Inorganic Oxide Particle

In the inorganic oxide particle-containing silicone resin sheet according to the present invention, the content of an inorganic oxide particle is, for example, 2 to 19% by weight, preferably 3 to 17% by weight, and more preferably 4 to 15% by weight. If the content of an inorganic oxide particle is too low, the mechanical strength is liable to decrease; and if the content of an inorganic oxide particle is too high, a sheet is liable to become brittle.

### Various Physical Properties of an Inorganic Oxide Particle-Containing Silicone Resin Sheet

The tensile elongation of the inorganic oxide particle-containing silicone resin sheet according to the present invention is 5 to 15%. In the case where the tensile elongation is lower than 5%, the flexibility is insufficient and the sheet is brittle and easily broken. In the case where the tensile elongation exceeds 15%, the sheet is too flexible and the practical utility is lacked. The tensile elongation of an inorganic oxide particle-containing silicone resin sheet can be regulated by the content of an inorganic oxide particle, the average primary particle diameter of the inorganic oxide particle, the kind of a polysiloxane resin, the blend ratio of a condensation-reactive group-containing polysilsesquioxane and a D/T-units condensation-reactive group-containing polysiloxane in the case of the concurrent use thereof, and the like.

The tensile elastic modulus of the inorganic oxide particle-containing silicone resin sheet according to the present invention is preferably in the range of 50 to 250 MPa (especially 80 to 240 MPa). In the case where the tensile elastic modulus is lower than 50 MPa, the sheet becomes too flexible in some cases; and in the case where that exceeds 250 MPa, the sheet becomes too hard in some cases. The tensile elastic modulus of an inorganic oxide particle-containing silicone resin sheet can be regulated by the content of an inorganic oxide particle, the average primary particle diameter of the inorganic oxide particle, the kind of a polysiloxane resin, the blend ratio of a condensation-reactive group-containing polysilsesquioxane and a D/T-units condensation-reactive group-containing polysiloxane in the case of the concurrent use thereof, and the like.

The 5%-weight loss temperature of the inorganic oxide particle-containing silicone resin sheet according to the present invention is preferably 380° C. or higher (for example, 380 to 500° C.). If the 5%-weight loss temperature is lower than 380° C., the heat resistance is liable to be insufficient. The 5%-weight loss temperature of an inorganic oxide particle-containing silicone resin sheet can be regulated by the content of an inorganic oxide particle, the kind of a polysiloxane resin, the blend ratio of a condensation-reactive group-containing polysilsesquioxane and a D/T-units condensation-reactive group-containing polysiloxane in the case of the concurrent use thereof, and the like.

The tensile strength of the inorganic oxide particle-containing silicone resin sheet according to the present invention is preferably 8 N/mm² or higher (for example, 8 to 25 N/mm²). If the tensile strength is lower than 8 N/mm², the mechanical strength of the sheet becomes insufficient in some cases. The tensile strength of an inorganic oxide particle-containing silicone resin sheet can be regulated by the content of an inorganic oxide particle, the average primary particle diameter of the inorganic oxide particle, the kind of a polysiloxane resin, the blend ratio of a condensation-reactive group-containing polysilsesquioxane and a D/T-units condensation-reactive group-containing polysiloxane in the case of the concurrent use thereof, and the like.

The total light transmittance (thickness: 100 μm) of the inorganic oxide particle-containing silicone resin sheet according to the present invention is preferably 88% or higher. In the case where the total light transmittance is lower than 88%, the transparency of the sheet is liable to become insufficient. The total light transmittance of an inorganic oxide particle-containing silicone resin sheet can be regulated, for example, by the kind of an inorganic oxide particle, the average primary particle diameter of the inorganic oxide particle and the like. Making small the average primary particle diameter of an inorganic oxide particle can raise the total light transmittance of the sheet.

### Production Method of an Inorganic Oxide Particle-Containing Silicone Resin Sheet

Then, a production method of the inorganic oxide particle-containing silicone resin sheet according to the present invention will be described.

The inorganic oxide particle-containing silicone resin sheet according to the present invention can be produced, for example, by causing the inorganic oxide particle to react with a polysiloxane resin (preferably a D/T-units condensation-reactive group-containing polysiloxane and/or a condensation-reactive group-containing polysilsesquioxane) in a solvent preferably in the presence of an acid.

The solvent includes water; alcohols such as methanol, ethanol, 2-propanol and 2-methoxyethanol; and mixed liquids thereof. Above all, a mixed solvent of water and an alcohol is preferable, and more preferable are a mixed solvent of water and 2-propanol and a mixed solvent of water, 2-propanol and 2-methoxyethanol.

Examples of the acid include inorganic acids such as hydrochloric acid, nitric acid, sulfuric acid and phosphoric acid; and organic acids such as acetic acid and p-toluenesulfonic acid. Above all, inorganic acids are preferable, and nitric acid is especially preferable. These acids can be used as an aqueous solution. The use amount of an acid may be any one as long as being capable of regulating pH of the reaction system at about 2 to 5 (preferably 2 to 4).

The reaction method is not especially limited, and any method can be used such as (i) a method in which a mixed liquid of a polysiloxane resin and a solvent is added to a mixed liquid of an inorganic oxide particle and a solvent, (ii) a method in which a mixed liquid of an inorganic oxide particle and a solvent is added to a mixed liquid of a polysiloxane resin and a solvent, and (iii) a method in which a mixed liquid of an inorganic oxide particle and a solvent and a mixed liquid of a polysiloxane resin and a solvent are together added to a solvent.

The reaction temperature is, for example, 40 to 150° C., and preferably 50 to 130° C. (for example, 80 to 130° C.). The reaction time is, for example, 0.5 to 24 hours (for example, 0.5 to 10 hours), and preferably 1 to 12 hours (for example, 1 to 5 hours).

In the case where a D/T-units condensation-reactive group-containing polysiloxane and a condensation-reactive group-containing polysilsesquioxane are concurrently used as a polysiloxane resin, an inorganic oxide particle and a mixture of the D/T-units condensation-reactive group-containing polysiloxane and the condensation-reactive group-containing polysilsesquioxane may be caused to react; and, first, an inorganic oxide particle may be caused to react with the D/T-units condensation-reactive group-containing polysiloxane, and then, the resultant may be caused to react with the condensation-reactive group-containing polysilsesquioxane; and further first, an inorganic oxide particle may be caused to react with the condensation-reactive group-containing polysilsesquioxane, and then, the resultant may be caused to react with the D/T-units condensation-reactive group-containing polysiloxane.

Above all, if a method is employed in which first, an inorganic oxide particle is caused to react with a condensation-reactive group silyl group-containing polysilsesquioxane, and then, the resultant is caused to react with a D/T-units condensation-reactive group-containing polysiloxane, a sheet can be obtained which simultaneously has all of a remarkably high heat resistance and strength and a very excellent flexibility. Particularly an inorganic oxide particle-containing silicone resin sheet, in which a crosslinked structure is formed by bonding of a condensation-reactive group-containing polysilsesquioxane having a T unit as a basic structural unit through a chemical bond to an inorganic oxide particle, and further bonding of a condensation-reactive group-containing polysiloxane having a D unit and a T unit as basic structural units to the condensation-reactive group-containing polysilsesquioxane having a T unit as a basic structural unit, is especially excellent in heat resistance, strength and flexibility. Hereinafter, this method will be described.

That is, a preferable production method of the inorganic oxide particle-containing silicone resin sheet according to the present invention comprises, at least, a first reaction step of causing an inorganic oxide particle to react with a condensation-reactive group-containing polysilsesquioxane having a T unit as a basic structural unit, a second reaction step of causing the reaction product obtained in the first reaction step to further react with a condensation-reactive group-containing polysiloxane having a D unit and a T unit as basic structural units, and a step of forming the reaction product obtained in the second reaction step into a film.

First, the first reaction step will be described. In the first reaction step, an inorganic oxide particle is caused to react with a condensation-reactive group-containing polysilsesquioxane having a T unit as a basic structural unit.

The reaction is carried out in a solvent preferably in the presence of an acid. The solvent usable is the solvents described above. The acid usable is the acids described above. The use amount of an acid may be any one as long as being capable of regulating pH of the reaction system at about 2 to 5 (preferably 2 to 4). The reaction method is not especially limited, and the methods (i), (ii) and (iii) described above can be employed.

The reaction temperature in the first reaction step is, for example, 40 to 150° C., and preferably 50 to 100° C. The reaction time is, for example, 0.3 to 8 hours (for example, 0.3 to 5 hours), and preferably 0.5 to 6 hours (for example, 0.5 to 3 hours).

Then, the second reaction step will be described. In the second reaction step, the reaction product obtained in the first reaction step is caused to further react (condensate) with a condensation-reactive group-containing polysiloxane having a D unit and a T unit as basic structural units. The reaction liquid itself obtained in the first reaction step may be used for the second reaction step, but may be used for the second reaction step after the reaction liquid is subjected to suitable treatments such as acidity regulation, concentration, dilution and solvent exchange. In this step, a condensation-reactive group of the condensation-reactive group-containing polysilsesquioxane having a T unit as a basic structural unit caused to react with an inorganic oxide particle in the first reaction step is caused to react with a condensation-reactive group of the condensation-reactive group-containing polysiloxane having a D unit and a T unit as basic structural units.

The reaction is carried out in a solvent. The solvent usable is the solvents described above. The reaction is preferably carried out in an acidic state. The pH of the reaction system is, for example, 2 to 5, and preferably 2 to 4. The reaction method is not especially limited, and any method may be used such as a method in which a mixed liquid of a condensation-reactive group-containing polysiloxane having a D unit and a T unit as basic structural units, and a solvent is added to the liquid containing the reaction product obtained in the first reaction step, and a method in which the liquid containing the reaction product obtained in the first reaction step is added to a mixed liquid of a condensation-reactive group-containing polysiloxane having a D unit and a T unit as basic structural units, and a solvent.

The reaction temperature in the second reaction step is, for example, 40 to 150° C. (for example, 50 to 150° C.), and preferably 60 to 130° C. The reaction time is, for example, 0.3 to 8 hours (for example, 0.3 to 5 hours), and preferably 0.5 to 6 hours (for example, 0.5 to 3 hours).

According to this preferable method, a high heat resistance and strength can be held by firmly bonding of an inorganic oxide particle having a strength with a polysilsesquioxane comprising a T unit, which can impart a hardness; and since a DT resin having a flexible D unit is then bonded, a high heat resistance and strength, and a flexibility can simultaneously be all satisfied. In the case where a DT resin is bonded after an inorganic oxide particle and the condensation-reactive group-containing polysilsesquioxane having a T unit as a basic structural unit are caused to react in the first stage, a toughness utilizing the particle crosslinking can be established more strongly; however, if the flexible DT resin is caused to react first with an inorganic oxide particle, although the particle crosslinking is weaker than the former case, and the resultant is flexible, the tensile strength becomes much lower than the former case.

In the film formation step, the reaction product obtained in the second reaction step is formed into a film. The reaction liquid as it is obtained in the second reaction step may be used for film formation, but may be used for the film formation step after the reaction liquid is subjected to suitable treatments such as acidity regulation, concentration, dilution, solvent exchange and cleaning. The reaction liquid may be used for film formation after a curing catalyst is added.

A film formation method is not especially limited, and known and common film formation methods can be employed; however, a method is preferably used in which a solution or a dispersion, liquid containing a reaction product (inorganic oxide particle-containing silicone resin composition) is applied on a base material for transfer, and dried, and as required, heat cured in order to complete the reaction to thereby form a film. The drying temperature is, for example, about 50 to 150° C. (for example, 80 to 150° C.). The heat curing temperature is, for example, about 40 to 250° C. (for example, 150 to 250° C.). The film formation step is not limited to the case of the two-stage reaction method described above, and can be applied generally to the production of an inorganic oxide particle-containing silicone resin sheet.

The base material for transfer to be usable is one having been subjected to a release treatment on the surface. The material of a base material for transfer is not especially limited, and includes thermoplastic resins such as polyester, thermosetting resins, metals and glasses.

Thus, an inorganic oxide particle-containing silicone resin sheet can be obtained which simultaneously has a high heat resistance and strength, and an excellent flexibility, and furthermore a high transparency. The thickness of an inorganic oxide particle-containing silicone resin sheet thus obtained can suitably be selected according to applications, but is usually 1 to 2,000 μm, preferably 10 to 500 μm, and more preferably 20 to 300 μm.

### Primer Composition

The primer composition according to the present invention is a primer composition used for a pressure-sensitive adhesive sheet having a pressure-sensitive adhesive layer containing a carboxyl group-containing polymer as a base polymer, and contains a crosslinked structure in which a polysiloxane compound is crosslinked through a chemical bond to the surface of a core comprising an inorganic oxide particle.

The content of the crosslinked structure in the primer composition according to the present invention is, for example, 50% by weight or higher, preferably 80% by weight or higher, more preferably 90% by weight or higher, and especially preferably 95% by weight or higher. The primer composition usually contains a solvent in order to secure coatability.

The inorganic oxide particle can be regarded similarly to an inorganic oxide particle in the inorganic oxide particle-containing silicone resin sheet. For example, the inorganic oxide particle is preferably a silica microparticle.

Here, the proportion of an inorganic oxide particle in the crosslinked structure is, for example, 1 to 30 parts by weight, and preferably 2 to 15 parts by weight, based on 100 parts by weight of the polysiloxane compound (for example, a condensation-reactive silicone resin).

The polysiloxane compound can be regarded similarly to a polysiloxane resin in the inorganic oxide particle-containing silicone resin sheet.

Here, in the case of using as the condensation-reactive silicone resin a combination of a D/T-units condensation-reactive group-containing polysiloxane and a condensation-reactive group-containing polysilsesquioxane, an undercoat layer excellent in heat resistance, strength and flexibility can be formed.

In the case of concurrently using a D/T-units condensation-reactive group-containing polysiloxane and a condensation-reactive group-containing polysilsesquioxane, the proportion of the both is preferably the former/the latter (weight ratio)=1/9 to 9/1, more preferably 1/3 to 3/1, and especially preferably 1/2 to 2/1. In this case, if the ratio of the condensation-reactive group-containing polysilsesquioxane is too high, an undercoat layer obtained by applying a primer composition on a base material is liable to become hard and brittle. If the ratio of the D/T-units condensation-reactive group-containing polysiloxane is too high, an undercoat layer obtained by applying a primer composition on a base material becomes too flexible, and the surface is liable to flaw in some cases.

### Method of Preparing a Primer Composition

Then, a method of preparing the primer composition according to the present invention will be described.

The primer composition according to the present invention is prepared, for example, by causing the inorganic oxide particle to react with a polysiloxane compound (for example, a condensation-reactive silicone resin, preferably a D/T-units condensation-reactive group-containing polysiloxane and/or a condensation-reactive group-containing polysilsesquioxane) in a solvent preferably in the presence of an acid.

The solvent includes water; alcohols such as methanol, ethanol, 2-propanol and 2-methoxyethanol; and mixed liquids thereof. Above all, a mixed solvent of water and an alcohol is preferable, and more preferable are a mixed solvent of water and 2-propanol and a mixed solvent of water, 2-propanol and 2-methoxyethanol. The primer composition according to the present invention does not need to use an organic solvent as a solvent, such as toluene or ethyl acetate, which is harmful to the environment, so coating can be carried out without giving harm to the environment.

Examples of the acid include inorganic acids such as hydrochloric acid, nitric acid, sulfuric acid and phosphoric acid; and organic acids such as acetic acid and p-toluenesulfonic acid. Above all, inorganic acids are preferable, and nitric acid is especially preferable. These acids can be used as an aqueous solution. The use amount of an acid may be any one as long as being capable of regulating the pH of the reaction system at about 2 to 5 (preferably 2 to 4).

The reaction method is desirably a method in which a mixed liquid of a polysiloxane compound and a solvent is added to a mixed liquid of an inorganic oxide particle and a solvent.

In the case where a D/T-units condensation-reactive group-containing polysiloxane and a condensation-reactive group-containing polysilsesquioxane are concurrently used as a polysiloxane compound, an inorganic oxide particle and a mixture of the D/T-units condensation-reactive group-containing polysiloxane and the condensation-reactive group-containing polysilsesquioxane may be caused to react; and, first, an inorganic oxide particle may be caused to react with the D/T-units condensation-reactive group-containing polysiloxane, and then, the resultant may be caused to react with the condensation-reactive group-containing polysilsesquioxane; and further first, an inorganic oxide particle may be caused to react with the condensation-reactive group-containing polysilsesquioxane, and then, the resultant may be caused to react with the D/T-units condensation-reactive group-containing polysiloxane. Above all, if a method is employed in which first, an inorganic oxide particle is caused to react with a condensation-reactive group silyl group-containing polysilsesquioxane, and then, the resultant is caused to react with a D/T-units condensation-reactive group-containing polysiloxane, an undercoat layer obtained from the primer composition can be imparted with an excellent flexibility.

The reaction temperature is, for example, 40 to 150° C., and preferably 80 to 130° C. The reaction time is, for example, 0.5 to 10 hours, and preferably 1 to 5 hours.

After the completion of the reaction, as required, the solvent can be distilled out to regulate the concentration and the viscosity to thereby obtain the primer composition according to the present invention. The solid content concentration of a primer composition is, for example, 1 to 70% by weight, and preferably 5 to 50% by weight, from the viewpoint of handleability, coatability and the like. To a primer composition, as required, additives such as a curing catalyst may be added.

### Use of the Primer Composition

The primer composition according to the present invention is used for formation of an undercoat layer of a pressure-sensitive adhesive sheet having a pressure-sensitive adhesive layer containing a carboxyl group-containing polymer as a base polymer.

Since the primer composition according to the present invention contains a crosslinked structure in which a polysiloxane compound is crosslinked through a chemical bond to the surface of a core comprising an inorganic oxide particle, the coatability is excellent, and an excellent anchoring force is exhibited probably due to formation of the intermolecular interaction such as the hydrogen bond between a site (particularly a condensation-reactive group) originated from a polysiloxane compound or the surface of an inorganic oxide particle in the crosslinked structure, and a carboxyl group contained in a pressure-sensitive adhesive, and due to other factors. Since the primer composition further has an excellent moisture resistance, even in a high-temperature high-humidity atmosphere, the primer composition can secure excellent reliability.

Therefore, the primer composition according to the present invention is suitably used as an undercoat agent interposed between a base material and a pressure-sensitive adhesive layer in a pressure-sensitive adhesive sheet. In more detail, the primer composition is suitably used, for example, as primer compositions for adhesive sheets in various types of industrial fields, such as primer compositions for medical adhesive sheets, and primer compositions for optical adhesive sheets, and particularly primer compositions for adhesive sheets for electronic devices.

### Carboxyl Group-Containing Polymer

Hereinafter, a carboxyl group-containing polymer as a base polymer of a pressure-sensitive adhesive will be described.

A carboxyl group-containing polymer is not especially limited as long as containing a carboxyl group in the polymer, but is preferably an acrylic polymer.

The acrylic polymer containing a carboxyl group is obtained, for example, by copolymerizing a (meth)acrylate ester, a carboxyl group-containing monomer, and as required, another copolymerizable monomer.

Examples of the carboxyl group-containing monomer include (meth)acrylic acid, itaconic acid, maleic acid, fumaric acid and bis(meth)acrylamideacetic acid. Note that the carboxyl group-containing monomer includes salts thereof. These carboxyl group-containing monomers may be used singly or in combinations of two or more.

Among the carboxyl group-containing monomers, (meth)acrylic acid is especially preferable.

Examples of (meth)acrylate esters include C₁-20 alkyl (meth)acrylates such as methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, s-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate and n-octadecyl(meth)acrylate.

Further examples of (meth)acrylate esters include cycloalkyl (meth)acrylates [for example, cyclohexyl (meth)acrylate and cyclopentyl (meth)acrylate], aralkyl (meth)acrylates [for example, benzyl (meth)acrylate], polycyclic (meth)acrylates [for example, 2-isobornyl (meth)acrylate, 2-norbornylmethyl (meth)acrylate, 5-norbornen-2-yl-methyl (meth)acrylate and 3-methyl-2-norbornylmethyl (meth)acrylate], hydroxyl group-containing (meth)acrylate esters [for example, hydroxyethyl (meth)acrylate, 2-hydroxypropyl (meth)acrylate and 2,3-dihydroxypropylmethyl-butyl (meth)methacrylate], alkoxy group- or phenoxy group-containing (meth)acrylate esters [2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, phenoxyethyl(meth)acrylate and the like], epoxy group-containing (meth)acrylate esters [for example, glycidyl (meth)acrylate], halogen atom-containing (meth)acrylate esters [for example, 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate and heptadecafluorodecyl (meth)acrylate], and alkylaminoalkyl (meth)acrylates [for example, dimethylaminoethyl (meth)acrylate].

These (meth)acrylate esters may be used singly or in combinations of two or more.

(Meth)acrylate esters are preferably C₁₋₂₀ alkyl (meth)acrylates, and more preferably C₁₋₁₀ alkyl (meth)acrylates.

Examples of the copolymerizable monomer include amide group-containing monomers [for example, (meth) acrylamide, N-methyl(meth)acrylamide, N-n-butyl(meth)acrylamide, N-1-propyl(meth)acrylamide, N-t-butyl(meth)acrylamide, N,N-dimethyl(meth)acrylamide, 2-(meth)acrylamide-2-methylpropanesulfonic acid, (meth)acrylamidepropyltrimethylammonium chloride, diacetone (meth) acrylamide, (meth) acryloylmorpholine and N-methylol (meth) acrylamide], cyano group-containing monomers [for example, (meth)acrylonitrile], vinyl esters (for example, vinyl acetate), aromatic vinyl compounds (for example, styrene, p-chlorostyrene, t-butylstyrene, α-methylstyrene and sodium styrenesulfonate), sulfonic acid group-containing monomers or salts thereof (for example, vinylsulfonic acid, sodium vinylsulfonate, sodium allylsulfonate and sodium methallylsulfonate), unsaturated polyvalent carboxylic acid derivatives (for example, esters such as dimethyl maleate, dibutyl maleate and diethyl fumarate, and N-substituted maleimides such as N-phenylmaleimide), N-vinyl polyvalent carboxylic acid imides (for example, N-vinylsuccinimide), dienes (for example, butadiene, cyclopentadiene and isoprene), heterocyclic vinyl monomers (for example, N-vinylpyrrolidone, N-vinyloxazolidone, 1-vinylimidazole and 4-vinylpyridine), N-vinylamides (N-vinylformamide, N-vinyl-N-methylformamide, N-vinylacetamide, N-vinyl-N-methylacetamide and the like), halogen atom-containing vinyl monomers (vinyl chloride, vinylidene chloride and the like), vinyl alkyl ethers (for example, methyl vinyl ether), and olefins (ethylene, propylene, 1-butene, isobutene and the like).

The copolymerizable monomer further includes polyfunctional copolymerizable monomers having two or more unsaturated groups.

Examples of the polyfunctional copolymerizable monomer include di(meth)acrylates [for example, 4,4′-isopropylidenediphenylene di(meth)acrylate, 1,3-butylene di(meth)acrylate, 1,4-cyclohexylenedimethylene di(meth)acrylate, ethylene glycol di(meth)acrylate, diethylene glycol di(meth)acrylate, triethylene glycol di(meth)acrylate, tetraethylene glycol di(meth)acrylate, tetramethylene di(meth)acrylate, diisopropylidene glycol di(meth)acrylate, ethylidene di(meth)acrylate, 2,2-dimethyl-1,3-trimethylene di(meth)acrylate, phenylethylene di(meth)acrylate and 2,2,2-trichloroethylidene di(meth)acrylate], tri(meth)acrylates [for example, pentaerythritol tri(meth)acrylate, trimethylolpropane tri(meth)acrylate, ethylidyne tri(meth)methacrylate and propyridine tri(meth)acrylate], tetra(meth)acrylates [for example, tetramethylolmethane tetra(meth)acrylate], and bis(meth)acrylamides [for example, N,N′-methylenebis(meth)acrylamide and N,N-(1,2-dihydroxy)ethylenebis(meth)acrylamide]; and further examples thereof include divinylbenzene, divinyloxymethane, allyl (meth)acrylate, 1,6-di(meth)acrylamidehexane, 1,3,5-tri(meth)acryloylhexahydro-s-triazine and vinylallyl oxyacetate.

The copolymerizable monomer further includes ones further having a known reactive group (for example, a hydroxyl group, an acid anhydride group and a glycidyl group) in order to structure crosslinking and the like.

These copolymerizable monomers may be used singly or in combinations of two or more.

The copolymerizable monomer is preferably vinyl esters and aromatic vinyl compounds.

In a carboxyl group-containing polymer (for example, an acrylic polymer containing a carboxyl group), the content proportion of a structural unit originated from a carboxyl group-containing monomer is preferably 1 to 10% by weight, and more preferably 2 to 8% by weight, based on all monomer structural units.

In the acrylic polymer containing a carboxyl group, the content proportion of a structural unit originated from a (meth)acrylate ester is preferably 90 to 99% by weight, and more preferably 92 to 98% by weight, based on all monomer structural units. In the acrylic polymer containing a carboxyl group, the content proportion of a structural unit originated from an alkyl (meth)acrylate is preferably 80 to 99% by weight, and more preferably 85 to 98% by weight, based on all monomer structural units.

### Synthesis Method of a Carboxyl Group-Containing Polymer

A synthesis method of the carboxyl group-containing polymer (for example, an acrylic polymer containing a carboxyl group) being a base polymer of a pressure-sensitive adhesive is not especially limited, and may be either one of emulsion polymerization and solution polymerization, but is desirably an emulsion polymerization method which does not use an organic solvent imparting a burden to the environment.

Hereinafter, the emulsion polymerization method will be described.

An emulsifier used in emulsion polymerization is not especially limited, and an emulsifier used commonly in emulsion polymerization of acrylic polymers and the like can be used. Examples of the emulsifier include anionic surfactants and nonionic surfactants.

Examples of the anionic surfactant include sodium lauryl sulfate, ammonium lauryl sulfate, sodium dodecylbenzenesulfonate, a sodium polyoxyethylene alkyl ether sulfate, an ammonium polyoxyethylene alkyl phenyl ether sulfate, a sodium polyoxyethylene alkyl phenyl ether sulfate and a sodium alkyl diphenyl ether disulfonate. These anionic surfactants may be used singly or in combinations of two or more.

Examples of the nonionic surfactant include proteins (gelatin, colloidal albumin, casein, lecithin, and the like), sugar derivatives (agar, starch derivatives, and the like), cellulosic derivatives (hydroxymethyl cellulose and the like), esters of polyhydric alcohols [ethylene glycol mono-fatty acid esters (for example, a monoglycol ester of oleic acid and a monoglycol ester of stearic acid), polyethylene glycol mono-fatty acid esters, propylene glycol mono-fatty acid esters, glycerol mono-fatty acid esters (for example, monoglyceride stearate), glycerol di-fatty acid esters, sucrose fatty acid esters, sorbitan fatty acid esters, and the like], and synthetic hydrophilic polymers [for example, polyvinyl alcohols, terminal long chain alkyl group-modified polyvinyl alcohols, vinyl polymers (homo- or copolymers containing a monomer having at least one ethylenic unsaturated group as a constituting element, such as hydroxyalkyl (meth)acrylates, alkyl vinyl ethers, vinyl acetate, (meth)acrylamide and diacetone acrylamide), polyoxyalkylenes (polyoxyethylene, polyoxypropylene), or derivatives thereof (for example, polyoxyethylene C₆₋₂₀ alkyl ethers (for example, polyoxyethylene lauryl ether and polyoxyethylene stearyl ether), and polyoxyethylene C₆₋₂₀ alkyl aryl ethers (for example, polyoxyethylene alkyl phenyl ethers (for example, polyoxyethylene octyl phenyl ethers, polyoxyethylene lauryl phenyl ethers and polyoxyethylene nonyl phenyl ethers)), and alkylene oxide adducts of fatty acid esters (for example, polyoxyethylene glycerol fatty acid esters, polyoxyethylene sucrose C₁₂₋₂₀ fatty acid esters and polyoxyethylene sorbitan C₁₂₋₂₀ fatty acid esters)], and further include polyoxyalkylene block copolymers (for example, polyoxyethylene-polyoxypropylene block copolymers), and polyoxyethylene C₆₋₂₀ alkyl phenyl ethers having at least one ethylenic unsaturated group (polymerizable unsaturated bond) such as an allyl group (for example, a 1-allyloxymethyl-2-nonylphenyloxyethanol ethylene oxide adduct).

The nonionic surfactant further include graft polymers, block polymers, macromers and the like in which an anchoring group and a dispersion stabilizing group are separated.

If a nonionic surfactant having an unsaturated bond (for example, vinyl, isopropenyl or (meth)acryloyl) is used as a nonionic surfactant, the nonionic surfactant adsorbed on the surface of an inorganic particle can be polymerized with a monomer component.

Nonionic surfactants are also commercially available, and examples of the commercially available products include trade names of “Emulgen 108” (a polyoxyethylene lauryl ether, made by Kao Corp., cloud point: 40° C.), “Emulgen 409P” (a polyoxyethylene stearyl ether, made by Kao Corp., cloud point: 55° C.) and “Emulgen 909” (a polyoxyethylene nonyl phenyl ether, made by Kao Corp., cloud point: 40° C.), and trade names of “Pluronic L61” (a polyoxyethylene-polyoxypropylene block copolymer, made by Adeka Corp., cloud point: 24° C.), “Pluronic L-64” (a polyoxyethylene-polyoxypropylene block copolymer, made by Adeka Corp., cloud point: 58° C.) and “NE-10” (a 1-allyloxymethyl-2-nonylphenyloxyethanol ethylene oxide adduct, made by Adeka Corp., cloud point: 40° C.).

These nonionic surfactants may be used singly or in combinations of two or more.

In the emulsion polymerization, as required, a polymerization initiator can be used.

Examples of the polymerization initiator include peroxides (for example, hydrogen peroxide), persulfate salts (for example, potassium persulfate and ammonium persulfate), aqueous azo compounds and redox polymerization initiators. These polymerization initiators may be used singly or in combinations of two or more.

The blend proportion of a polymerization initiator is suitably selected depending on the object and the application.

In the emulsion polymerization, in order to regulate the molecular weight of a resin, for example, a chain-transfer agent can further be used.

Examples of the chain-transfer agent include organic peroxides soluble in vinyl monomers, organic azo compounds, halogenated hydrocarbons (carbon tetrachloride and the like), mercaptans and thiols. These chain-transfer agents may be used singly or in combinations of two or more.

The addition proportion of a chain-transfer agent is, for example, 5 parts by weight or lower based on 100 parts by weight of a monomer component.

In the emulsion polymerization, as required, a pH regulating agent [for example, an acid (sulfuric acid, hydrochloric acid or the like), ammonia, an amine or the like] is added to a reaction system (polymerization system) and/or an aqueous dispersion after the completion of the reaction to be thereby able to regulate the pH of the reaction system (polymerization system) and/or the aqueous dispersion, for example, at 7 to 9, preferably 7.5 to 8.5.

In the emulsion polymerization, as required, a crosslinking agent can further be used.

The crosslinking agent is not especially limited, and includes known crosslinking agents, and more specific examples thereof include isocyanate-based crosslinking agents, epoxy-based crosslinking agents, oxazoline-based crosslinking agents, aziridine-based crosslinking agents and metal chelate-based crosslinking agents. These crosslinking agents may be used singly or in combinations of two or more.

The addition proportion of a crosslinking agent is suitably selected depending on the object and the application.

### Adhesive Sheet

The pressure-sensitive adhesive sheet according to the present invention has a base material, and a pressure-sensitive adhesive layer containing a carboxyl group-containing polymer as a base polymer, and has an undercoat layer formed of the primer composition according to the present invention between the base material and the pressure-sensitive adhesive layer. In the pressure-sensitive adhesive sheet, the carboxyl group-containing polymer is preferably an acrylic polymer containing 1 to 10% by weight of a structural unit originated from a carboxyl group-containing monomer based on all monomer structural units. The pressure-sensitive adhesive layer is preferably formed of an emulsion-based adhesive composition.

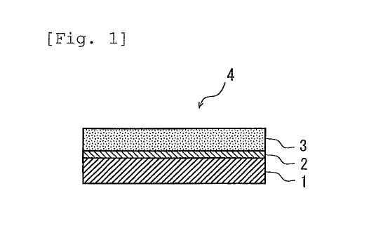

FIG. 1 is a schematic enlarged cross-sectional diagram of one embodiment of the pressure-sensitive adhesive sheet according to the present invention. In FIG. 1, the pressure-sensitive adhesive sheet 4 has a base material 1, an undercoat layer 2 laminated on the surface of the base material 1, and a pressure-sensitive adhesive layer 3 laminated on the surface of the undercoat layer 2.

The base material 1 is formed, for example, in a sheet shape. Examples of a material to form the base material 1 include resins including thermoplastic resins such as polyesters [for example, polyethylene terephthalate (PET) and polyethylene naphthalate (PEN)], polyvinyl chloride, polyolefins (for example, polyethylene and polypropylene), ethylene-vinyl acetate copolymers, polyvinyl alcohols, polyamides and thermoplastic polyurethanes; and thermosetting resins (heat resistant resins) such as polyimides. To the above-mentioned resin, as required, additives such as a filler, an antioxidant, a vulcanizing agent, a vulcanization accelerator and an antiaging agent may be added in a suitable proportion. The base material 1 also includes nonwoven fabrics formed of the above-mentioned resins. The material to form the base material 1 is preferably a thermoplastic resin.

The surface (the surface of the undercoat layer side) of the base material 1 can be subjected to, for example, a surface treatment such as corona treatment.

The thickness of the base material 1 is not especially limited, but is, for example, 1 to 1,000 μm, and preferably 5 to 500 μm.

The pressure-sensitive adhesive layer 3 is formed of a pressure-sensitive adhesive composition. The pressure-sensitive adhesive composition is preferably an emulsion-based adhesive composition from the viewpoint of not imparting a burden to the environment. Although a pressure-sensitive adhesive layer formed of an emulsion-based adhesive composition is generally liable to leave adhesive residue, if an undercoat layer comprising the primer composition according to the present invention is provided between a base material and the pressure-sensitive adhesive layer, since the anchoring force increases even if the pressure-sensitive adhesive layer is one formed of the emulsion-based adhesive composition, an effect of the undercoat layer is remarkable.

An emulsion-based adhesive composition can be prepared, for example, by the above-mentioned emulsion polymerization method. In a carboxyl group-containing polymer being a base polymer in the pressure-sensitive adhesive composition, the proportion of a structural unit originated from a carboxyl group-containing monomer is preferably 1 to 10% by weight based on all monomer structural units, as described above. In a pressure-sensitive adhesive sheet having a pressure-sensitive adhesive layer formed of such a pressure-sensitive adhesive composition, the effect of improving the anchoring force particularly by the primer composition according to the present invention is remarkable.

To the pressure-sensitive adhesive layer 3, in addition to the base polymer, as required, additives may be added including, for example, a silane coupling agent such as an aminosilane [specifically for example, an (alkoxy)aminosilane such as γ-aminopropyltrimethoxysilane], a tackifier such as a rosin type, terpene type and petroleum type ones, and a crosslinking agent such as an isocyanate-based, epoxy-based and metal ion-based ones. These additives are added to a pressure-sensitive adhesive composition at a suitable stage.

These additives may be used singly or concurrently in two or more. The blend proportion of additives is, for example, 50 parts by weight or lower (for example, 1 to 50 parts by weight), and preferably 35 parts by weight or lower (for example, 5 to 35 parts by weight), based on 100 parts by weight of the solid content of the pressure-sensitive adhesive composition.

The pressure-sensitive adhesive sheet 4 according to the present invention can be produced, for example, as follows. That is, first, a base material 1 is prepared, and then, an undercoat layer 2 is provided on the surface of the base material 1. The undercoat layer 2 is formed of the primer composition according to the present invention.

In order to provide the undercoat layer 2, a coated film is formed, for example, by directly applying the primer composition on the surface of the base material 1 by a known coating method such as kiss coating, gravure coating, bar coating, spray coating, knife coating or wire coating.

Thereafter, the coated film, as required, can be heated and dried, for example, at 80 to 150° C. for 1 to 10 min to thereby provide the undercoat layer 2 on the surface of the base material 1.

The thickness of the undercoat layer 2 thus provided is, for example, 0.05 to 20 μm, preferably 0.1 to 10 μm, and more preferably 0.1 to 5 μm.

Then, the pressure-sensitive adhesive composition is applied directly on the surface of the undercoat layer 2 by the same coating method as the above. Thereafter, the resultant can be heated and dried, for example, at 80 to 150° C. for 1 to 10 min to thereby provide a pressure-sensitive adhesive layer 3 on the surface of the undercoat layer 2.

Alternatively, a pressure-sensitive adhesive layer 3 may be provided on the surface of an undercoat layer 2 by transfer. Specifically, the pressure-sensitive adhesive layer 3 can be laminated on a release sheet (not shown in FIGURE); the pressure-sensitive adhesive layer 3 is pasted on the undercoat layer 2; and thereafter, the release sheet is peeled off the pressure-sensitive adhesive layer 3 to thereby form the pressure-sensitive adhesive layer 3.

The thickness of the pressure-sensitive adhesive layer 3 thus provided is, for example, 1 to 100 μm, preferably 3 to 50 μm, and more preferably 5 to 40 μm.

The pressure-sensitive adhesive sheet 4 thus formed is used, for example, for various types of industrial fields such as medical adhesive sheets and optical adhesive sheets, and preferably for adhesive sheets for electronic devices and the like.

In FIG. 1, the undercoat layer 2 is provided on one surface of the base material 1, but the undercoat layer 2 may be provided on both surfaces of the base material 1.

The above-mentioned adhesive sheet 4 includes, for example, adhesive films and adhesive tapes.

In the production of such a pressure-sensitive adhesive sheet, since the primer composition has a crosslinked structure in which an inorganic oxide particle and a polysiloxane compound are bonded through a chemical bond, the coatability is excellent. Due to the condensation-reactive group (alkoxysilyl group and the like) in the inorganic oxide particle-containing polysiloxane resin, the anchoring force of the pressure-sensitive adhesive layer is remarkably improved and the adhesion reliability to a base material largely increases.

Specifically in a peel test described later, although anchoring fractures in which the fractures are observed between an undercoat layer 2 and a base material 1 (at the interface), or interfacial fractures in which the fractures are observed between the undercoat layer 2 and a pressure-sensitive adhesive layer 3 (at the interface) are usually caused in a pressure-sensitive adhesive sheet, in the pressure-sensitive adhesive sheet according to the present invention, interfacial fractures in which the fractures are observed preferably between an adherend and the pressure-sensitive adhesive layer 3 are caused.

Since such a pressure-sensitive adhesive sheet 4 has an excellent moisture resistance, the pressure-sensitive adhesive sheet 4 can secure excellent reliability even in a high-temperature high-humidity atmosphere.

### EXAMPLES

Hereinafter, the present invention will be described more specifically by way of Examples and Comparative Examples. However, the present invention is not in any way limited thereto. In the following description, “parts” and “%” are based on weight unless otherwise specified.

### Example 1

15 g of a solution of a colloidal silica having an average particle diameter of 8 to 11 nm (trade name: Snowtex OS, made by Nissan Chemical Industries, Ltd., solid content concentration: 20%), 15 g of 2-propanol and g of 2-methoxyethanol were added to a vessel equipped with a stirrer, a reflux cooler and a nitrogen introducing tube. A concentrated nitric acid was added to regulate the acidity (pH) of the liquid in the range of 2 to 4. Then, the liquid was heated to 70° C., and then, a liquid in which 25 g of a silsesquioxane compound having reactive methoxysilyl groups at the molecular terminals (trade name: X-40-9225, made by Shin-Etsu Chemical Co., Ltd., methoxy content: 24%) was dissolved in 25 g of 2-propanol was dropped over 1 hour using a dropping funnel to cause the silsesquioxane compound to react with the particle surface of the colloidal silica.

Then, a liquid in which 35 g of a polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) was dissolved in 35 g of 2-propanol was dropped over 1 hour to cause the polysiloxane compound to react with the silsesquioxane compound on the colloidal silica. The resultant was heated and stirred at 100° C. for 1 hour; and thereafter, the solvent was distilled out by a rotary evaporator; then, 80 g of toluene was added to the resultant, and heated and stirred at 100° C. for 1 hour. The resultant was cooled to room temperature; and the solvent was distilled out to regulate the viscosity to thereby obtain a resin solution.

The resin solution was coated on a polyethylene terephthalate (PET) sheet (film thickness: 38 μm, trade name: “MRF-38”, made by Mitsubishi Plastics, Inc.) having been subjected to a release treatment with a silicone-based release agent so that the film thickness after drying became 100 μm, and held in an oven at 100° C. for 10 min and at 200° C. for 30 min to obtain an inorganic oxide particle-containing silicone resin sheet A as a target.

### Example 2

An inorganic oxide particle-containing silicone resin sheet B was obtained by using the same experimental apparatus as in Example 1 and by carrying out the same operation as in Example 1, except for altering the amount of the silsesquioxane compound having reactive methoxysilyl groups at the molecular terminals (trade name: X-40-9225, made by Shin-Etsu Chemical Co., Ltd., methoxy content: 24%) to 30 g, the amount of 2-propanol for the dissolution to 30 g, the amount of the polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) to 30 g, and the amount of 2-propanol for the dissolution to 30 g.

### Example 3

An inorganic oxide particle-containing silicone resin sheet C was obtained by using the same experimental apparatus as in Example 1 and by carrying out the same operation as in Example 1, except for altering the amount of the silsesquioxane compound having reactive methoxysilyl groups at the molecular terminals (trade name: X-40-9225, made by Shin-Etsu Chemical Co., Ltd., methoxy content: 24%) to 20 g, the amount of 2-propanol for the dissolution to 20 g, the amount of the polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) to 40 g, and the amount of 2-propanol for the dissolution to 40 g.

### Example 4

An inorganic oxide particle-containing silicone resin sheet D was obtained by using the same experimental apparatus as in Example 1 and by carrying out the same operation as in Example 1, except for altering the amount of the solution of the colloidal silica having an average particle diameter of 8 to 11 nm (trade name: Snowtex OS, made by Nissan Chemical Industries, Ltd., solid content concentration: 20%) to 30 g, and the amount of 2-propanol in the earlier stage to 30 g.

### Example 5

An inorganic oxide particle-containing silicone resin sheet E was obtained by using the same experimental apparatus as in Example 1 and by carrying out the same operation as in Example 1, except for using 25 g of a trade name of “KR-500” (made by Shin-Etsu Chemical Co., Ltd., methoxy content: 28%) in place of the trade name of “X-40-9225” as a silsesquioxane compound having reactive methoxysilyl groups at the molecular terminals.

### Example 6

An inorganic oxide particle-containing silicone resin sheet F was obtained by using the same experimental apparatus as in Example 1 and by carrying out the same operation as in Example 1, except for using 10 g of a solution of a colloidal silica having an average particle diameter of 20 nm (trade name: Snowtex 0-40, made by Nissan Chemical Industries, Ltd., solid content concentration: 40%) in place of the solution of the colloidal silica having an average particle diameter of 8 to 11 nm (trade name: Snowtex OS, made by Nissan Chemical Industries, Ltd., solid content concentration: 20%) as an inorganic oxide particle.

### Comparative Example 1

An inorganic oxide particle-containing silicone resin sheet G was obtained by using the same experimental apparatus as in Example 1 and by carrying out the same operation as in Example 1, except for increasing the amount of the solution of the colloidal silica having an average particle diameter of 8 to 11 nm (trade name: Snowtex OS, made by Nissan Chemical Industries, Ltd., solid content concentration: 20%) to 75 g, and increasing the amount of 2-propanol in the earlier stage to 75 g.

### Comparative Example 2

The same experimental apparatus as in Example 1 was used, and the same operation as in Example 1 was carried out, except for altering the amount of the solution of the colloidal silica having an average particle diameter of 8 to 11 nm (trade name: Snowtex OS, made by Nissan Chemical Industries, Ltd., solid content concentration: 20%) to 1.5 g, and the amount of 2-propanol in the earlier stage to 1.5 g. The viscosity of the resin solution was low, and a sheet of 100 μm in film thickness could not be obtained.

### Comparative Example 3

An inorganic oxide particle-containing silicone resin sheet H was obtained by using the same experimental apparatus as in Example 1 and by carrying out the same operation as in Example 1, except for altering the amount of the silsesquioxane compound having reactive methoxysilyl groups at the molecular terminals (trade name: X-40-9225, made by Shin-Etsu Chemical Co., Ltd., methoxy content: 24%) to 40 g, and the amount of 2-propanol for the dissolution to 40 g, and further altering the amount of the polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) to 30 g, and the amount of 2-propanol for the dissolution to 30 g.

### Comparative Example 4

An inorganic oxide particle-containing silicone resin sheet I was obtained by using the same experimental apparatus as in. Example 1 and by carrying out the same operation as in Example 1, except for altering the amount of the silsesquioxane compound having reactive methoxysilyl groups at the molecular terminals (trade name: X-40-9225, made by Shin-Etsu Chemical Co., Ltd., methoxy content: 24%) to 17.4 g, and the amount of 2-propanol for the dissolution to 17 g, and further altering the amount of the polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) to 52.6 g, and the amount of 2-propanol for the dissolution to 53 g.

### Comparative Example 5

A water-dispersion liquid of an inorganic oxide particle was obtained by dispersing 20 g of a fused silica having an average particle diameter of about 300 nm (trade name: SFP-20M, made by Denki Kagaku Kogyo K.K.) used as the inorganic oxide particle in 80 g of water using an ultrasonic homogenizer. The dispersion liquid was cloudy. An inorganic oxide particle-containing silicone resin sheet J was obtained by carrying out the same operation as in Example 1, except for using 15 g of the dispersion liquid in place of the solution of the colloidal silica having an average particle diameter of 8 to 11 nm (trade name: Snowtex OS, made by Nissan Chemical Industries, Ltd., solid content concentration: 20%).

<Evaluations>

The following evaluations were carried out for the each inorganic oxide particle-containing silicone resin sheet obtained in the Examples and the Comparative Examples.

(1) Total Light Transmittance

The total light transmittance (%) (thickness: 100 μm) was measured using a haze meter (trade name: “HM-150”), made by Murakami Color Research Laboratory Co., Ltd.

(2) Physical Properties of a Sheet

An inorganic oxide particle-containing silicone resin sheet of 100 μm in thickness was cut into 5 cm long×1 cm wide, set on the chuck part of an Autograph (made by Shimadzu Corp.) with a between-chuck distance of 2 cm, and was subjected to a tensile test at a rate of 300 mm/min to measure a tensile elastic modulus (MPa), a tensile strength (N/mm²) and a tensile elongation (%).

(3) 5%-Weight Loss Temperature

A Tg/DTA apparatus (Seiko Instruments Inc.) was used for the measurement. A sample was packed in a ceramic pan, and the weight loss was measured with air being made to flow and with the temperature being raised from room temperature to 1,000° C. at a temperature-rise rate of 10° C./min; and a temperature at which the weight loss ratio was 5% was defined as a 5%-weight loss temperature.

(4) Flexibility

Wires of from 0.1 mm to 10 mm in diameter were prepared; one inorganic oxide particle-containing silicone resin sheet was wound on one wire, and a diameter of the wire at which the sheet cracked was taken as an evaluation of the flexibility. A sheet which did not crack even at a diameter of 0.1 mm was evaluated as ◯. A sheet which cracked even at a diameter of 10 mm was evaluated as X.

The results are shown in Table 1. In Table 1, “silica amount” indicates a proportion (% by weight) of silica (SiO₂) to the total weight of a raw material (in terms of solid content). “Silsesquioxane” means a silsesquioxane compound having reactive methoxysilyl groups at the molecular terminals. “Polysiloxane” means a polysiloxane compound having reactive methoxysilyl groups at the molecular terminals and derived from a trifunctional alkoxysilane and a bifunctional alkoxysilane. “Silsesquioxane/polysiloxane” indicates a weight ratio of the “silsesquioxane” to the “polysiloxane”.

TABLE 1

| | | | | | Tensile | | | 5%-Weight | |
|---|---|---|---|---|---|---|---|---|---|
| | | Silica | | Total Light | Elastic | Tensile | Tensile | Loss | |
| | | Amount | Silsesquioxane/ | Transmittance | Modulus | Strength | Elongation | Temperature | Flexibility |
| | Sample Name | (%) | Polysiloxane | (%) | (MPa) | (N/mm²) | (%) | (° C.) | (mm) |
| Example 1 | A | 4.8 | 1/1.4 | 94 | 149.4 | 13.5 | 11.5 | 401 | “Excellent” |
| Example 2 | B | 4.8 | 1/1 | 94 | 207.8 | 19.1 | 8.5 | 437 | 0.2 |
| Example 3 | C | 4.8 | 1/2 | 94 | 117.2 | 9.3 | 13.8 | 389 | “Excellent” |
| Example 4 | D | 9.6 | 1/1.4 | 93 | 189.8 | 14.2 | 9.5 | 420 | 0.1 |
| Example 5 | E | 4.8 | 1/1.4 | 94 | 223.8 | 11.8 | 7.6 | 438 | 0.3 |
| Example 6 | F | 6.3 | 1/1.4 | 90 | 185.5 | 11.1 | 9.8 | 406 | 0.2 |
| Comparative | G | 20 | 1/1.4 | 94 | 247.6 | 11.5 | 3.1 | 423 | “Poor” |
| Example 1 | | | | | | | | | |
| Comparative | could not be | 0.49 | 1/1.4 | — | — | — | — | — | — |
| Example 2 | fabricated | | | | | | | | |
| Comparative | H | 4.8 | 1.3/1 | 93 | 256.2 | 17.7 | 1.7 | 418 | “Poor” |
| Example 3 | | | | | | | | | |
| Comparative | I | 4.8 | 1/3 | 94 | 25.8 | 6.4 | 20.1 | 375 | “Excellent” |
| Example 4 | | | | | | | | | |
| Comparative | J | 4.8 | 1/1.4 | 48 | 358.5 | 2.6 | 0.5 | 399 | “Poor” |
| Example 5 | | | | | | | | | |

### Production Example 1

### Production of a Primer Composition A)

15 g of a solution of a colloidal silica having an average particle diameter of 8 to 11 nm (trade name: Snowtex OS, made by Nissan Chemical Industries, Ltd., solid content concentration: 20%), 15 g of 2-propanol and 5 g of 2-methoxyethanol were added to a vessel equipped with a stirrer, a reflux cooler and a nitrogen introducing tube. A concentrated nitric acid was added to regulate the acidity (pH) of the liquid in the range of 2 to 4. Then, the liquid was heated to 70° C., and then, a liquid in which 30 g of a silsesquioxane compound having reactive methoxysilyl groups at the molecular terminals (trade name: X-40-9225, made by Shin-Etsu Chemical Co., Ltd., methoxy content: 24%) was dissolved in 30 g of 2-propanol was dropped over 1 hour using a dropping funnel to cause the silsesquioxane compound to react with the particle surface of the colloidal silica. Then, a liquid in which 30 g of a polysiloxane compound having reactive methoxysilyl groups at the molecular terminals and derived from a trifunctional alkoxysilane and a bifunctional alkoxysilane (trade name: X-40-9246, made by Shin-Etsu Chemical Co., Ltd., methoxy content: 12%) was dissolved in 30 g of 2-propanol was dropped over 1 hour to cause the polysiloxane compound to react with the silsesquioxane compound. The resultant was heated and stirred at 100° C. for 1 hour, and then cooled to room temperature; and the solvent was distilled out to regulate the viscosity to thereby obtain a primer composition A (solid content concentration: 10%).

### Production Example 2

### Production of a Primer Composition B

A primer composition B (solid content concentration: 10%) was obtained by carrying out the same operation as in Production Example 1, except for altering the silsesquioxane compound from the trade name of “X-40-9225” to the trade name of “KR500” (made by Shin-Etsu Chemical Co., Ltd., methoxy content: 28%).

### Production Example 3

### Production of a Pressure-Sensitive Adhesive Composition a; a Carboxyl Group-Containing Polymer

In a reaction vessel equipped with a cooling pipe, a nitrogen introducing tube, a thermometer and a stirrer, 96 parts of butyl acrylate, 4 parts of acrylic acid, 0.1 parts of 2,2′-azobis[2-(5-methyl-2-imidazolin-2-yl)propane dihydrochloride, and 0.05 parts of 1-dodecanethiol were added to 100 parts of water containing 1.5 parts of a sodium polyoxyethylene lauryl sulfate added therein, and emulsion polymerized; thereafter, a 10% ammonium water was added to regulate the pH to 8 to thereby prepare a water-dispersion liquid of an acrylic copolymer having a (meth)acrylate ester as a main component. 30 Parts of a rosin-based resin (trade name: “Super Ester E-100”, made by Arakawa Chemical Industries, Ltd.) based on 100 parts of the solid content of the water-dispersion liquid was added to the water-dispersion liquid to thereby obtain a water-dispersion type adhesive composition a.

The water-dispersion type adhesive composition a was coated on a release liner (made by Mitsubishi Plastics, Inc., trade name: “MRF38”) in which a silicone-based release agent had been coated, and dried at 120° C. for 3 min to thereby obtain a release liner having a pressure-sensitive adhesive layer of 23 μm in thickness laminated therein.

### Production Example 4

### Production of a Pressure-Sensitive Adhesive Composition B; a Polymer Containing No Carboxyl Group

The emulsion polymerization was carried out under the same conditions as in Production Example 3, except for using 100 parts of butyl acrylate and adding no acrylic acid. A water-dispersion liquid was prepared without adding an ammonia water. 30 Parts of a rosin-based resin(trade name: “Super Ester E-100”, made by Arakawa Chemical Industries, Ltd.) based on 100 parts of the solid content of the water-dispersion liquid was added to the water-dispersion liquid to thereby obtain a water-dispersion type adhesive composition b.

The water-dispersion type adhesive composition b was coated on a release liner (made by Mitsubishi Plastics, Inc., trade name: “MRF38”) in which a silicone-based release agent had been coated, and dried at 120° C. for 3 min to thereby obtain a release liner having a pressure-sensitive adhesive layer of 23 μm in thickness laminated therein.

### Example 7

The primer composition A obtained in Production Example 1 was uniformly coated on a base material composed of a surface-untreated polyethylene terephthalate (PET) film (trade name: “LumilarLumirror S10”, #38, made by Toray Industries, Inc.) by using a wire bar No. 5 to thereby form an undercoat layer (thickness: 1 μm). Then, the pressure-sensitive adhesive layer (thickness: 23 μm) was transferred from the release liner having the pressure-sensitive adhesive layer laminated therein obtained in Production Example 3 onto the undercoat layer to thereby obtain a pressure-sensitive adhesive sheet.

### Example 8

The primer composition B obtained in Production Example 2 was uniformly coated on a base material composed of a surface-untreated PET film (trade name: “Lumirror S10”, #38, made by Toray Industries, Inc.) by using a wire bar No. 5 to thereby form an undercoat layer (thickness: 1 μm). Then, the pressure-sensitive adhesive layer (thickness: 23 μm) was transferred from the release liner having the pressure-sensitive adhesive layer laminated therein obtained in Production Example 3 onto the undercoat layer to thereby obtain a pressure-sensitive adhesive sheet.

### Comparative Example 6

The pressure-sensitive adhesive layer (thickness: 23 μm) was transferred from the release liner having the pressure-sensitive adhesive layer laminated therein obtained in Production Example 3 onto a base material composed of a surface-untreated PET film (trade name: “Lumirror S10”, #38, made by Toray Industries, Inc.), without forming an undercoat layer, to thereby obtain a pressure-sensitive adhesive sheet.

### Comparative Example 7

The primer composition A obtained in Production Example 1 was uniformly coated on a base material composed of a surface-untreated PET film (trade name: “Lumirror S10”, #38, made by Toray Industries, Inc.) by using a wire bar No. 5 to thereby form an undercoat layer (thickness: 1 μm). Then, the pressure-sensitive adhesive layer (thickness: 23 μm) was transferred from the release liner having the pressure-sensitive adhesive layer laminated therein obtained in Production Example 3 onto the undercoat layer to thereby obtain a pressure-sensitive adhesive sheet.

<Evaluation: Peel Test>

(1) In a Normal-Temperature Normal-Humidity Atmosphere

The pressure-sensitive adhesive sheets of Examples 7 and 8 and Comparative Examples 6 and 7 were cut into 25 mm wide×100 mm long to prepare samples. The pressure-sensitive adhesive layer of the each sample was laminated on an undercoat layer formed by coating an undercoat agent (trade name: “RC-1023”, made by Lord Corp.) on a PET base material; after the elapse of several minutes, the laminated sample was compression bonded using a 2-kg roller; and the state of peeling when the sample was peeled under the following peeling conditions was visually observed and evaluated. The adhesive force at peeling was also measured.

That is, the peeling was carried out as a 180°-peel test using a universal tensile tester (TCM-1 kNB, made by Minebea Co., Ltd.) in the room temperature (23° C.) atmosphere at a cross head speed (peeling speed) of 300 mm/min.

(2) In a high-temperature high-humidity atmosphere The pressure-sensitive adhesive sheets of Examples 7 and 8 and Comparative Examples 6 and 7 were cut into 25 mm wide×100 mm long to prepare samples, which were allowed to stand for 1 week in a 40° C., 92% RH constant-temperature high-humidity bath. Thereafter, the each sample was taken out; the pressure-sensitive adhesive layer of the each sample was laminated on an undercoat layer formed by coating an undercoat agent (trade name: “RC-1023”, made by Lord Corp.) on a PET base material; and thereafter, the 180°-peel test was carried out as in the above (1).

The above results are shown together in Table 2. In the case of Examples 7 and 8 and Comparative Example 7, interfacial fractures were observed between the PET base material (adherend) and the pressure-sensitive adhesive layer; and in the case of Comparative Example 6, interfacial fractures were observed between the surface-untreated PET film (trade name: “Lumirror S10”, #38, made by Toray Industries, Inc.) and the pressure-sensitive adhesive layer.

TABLE 2

| | | | Anchoring force (N/25 mm) | |
|---|---|---|---|---|
| | | | Room | |
| | Primer | Adhesive | temperature | 40° C., |
| | Composition | Composition | (23° C.) | 92% RH |
| Example 7 | A | a | 20 | 20 |
| Example 8 | B | a | 20 | 19 |
| Comparative | none | a | 12 | 8 |
| Example 6 | | | | |
| Comparative | A | b | 15 | 11 |
| Example 7 | | | | |

### REFERENCE SIGNS LIST

1 BASE MATERIAL
2 UNDERCOAT LAYER
3 ADHESIVE LAYER
4 ADHESIVE SHEET

### INDUSTRIAL APPLICABILITY

Since the inorganic oxide particle-containing silicone resin sheet according to the present invention has a strength and heat resistance comparable with glasses, and furthermore a flexibility and transparency, the silicone resin sheet can suitably be used particularly for applications requiring size reduction, thickness reduction and weight reduction, such as surface sheets of flexible displays, flexible solar cells, OLED illuminations and the like, or sheets attached on curved surfaces and the like.

The primer composition according to the present invention is suitably used as an undercoat agent interposed between a base material and a pressure-sensitive adhesive layer in a pressure-sensitive adhesive sheet. In more detail, the primer composition is suitably used, for example, as a primer composition for adhesive sheets in various types of industrial fields, such as a primer composition for medical adhesive sheets and a primer composition for optical adhesive sheets, particularly a primer composition for adhesive sheets for electronic devices.

1. An inorganic oxide particle-containing silicone resin sheet, comprising a silicone resin composition comprising a crosslinked structure in which an inorganic oxide particle dispersed in a polysiloxane resin and the polysiloxane resin are crosslinked through a chemical bond, wherein the resin sheet has a tensile elongation of 5 to 15%.

2. The inorganic oxide particle-containing silicone resin sheet according to claim 1, wherein the resin sheet has a tensile elastic modulus of 50 to 250 MPa.

3. The inorganic oxide particle-containing silicone resin sheet according to claim 1, wherein the resin sheet exhibits a 5%-weight loss temperature of 380° C. or higher.

4. The inorganic oxide particle-containing silicone resin sheet according to claim 1, wherein the resin sheet has a total light transmittance (thickness: 100 μm) of 88% or higher.

5. The inorganic oxide particle-containing silicone resin sheet according to claim 1, wherein the resin sheet has a tensile strength of 8 N/mm² or higher.

6. The inorganic oxide particle-containing silicone resin sheet according to claim 1, wherein as the polysiloxane resin, a condensation-reactive group-containing polysilsesquioxane having a T unit as a basic structural unit, and a condensation-reactive group-containing polysiloxane having a D unit and a T unit as basic structural units are used.

7. A primer composition for a carboxyl group-containing adhesive, being used for a pressure-sensitive adhesive sheet having a pressure-sensitive adhesive layer comprising a carboxyl group-containing polymer as a base polymer, wherein the primer composition comprises a crosslinked structure in which a polysiloxane compound is crosslinked through a chemical bond to a surface of a core comprising an inorganic oxide particle.

8. The primer composition for a carboxyl group-containing adhesive according to claim 7, wherein a proportion of the inorganic oxide particle in the crosslinked structure is 1 to 30 parts by weight based on 100 parts by weight of the polysiloxane compound.

9. The primer composition for a carboxyl group-containing adhesive according to claim 7, wherein the polysiloxane compound is an alkoxysilyl group-containing polysiloxane having a D unit and a T unit as basic structural units, and/or an alkoxysilyl group-containing polysilsesquioxane having a T unit as a basic structural unit.

10. A pressure-sensitive adhesive sheet having a base material and a pressure-sensitive adhesive layer comprising a carboxyl group-containing polymer as a base polymer, the pressure-sensitive adhesive sheet comprising an undercoat layer formed of a primer composition for a carboxyl group-containing adhesive according to claim 7 between the base material and the pressure-sensitive adhesive layer, wherein the carboxyl group-containing polymer is an acrylic polymer containing 1 to 10% by weight of a structural unit originated from a carboxyl group-containing monomer based on all monomer structural units.
